(19) United States
(12) Patent Application Publication
(10) Pub. No.: US 2022/0268546 A1
(43) Pub. Date: Aug. 25, 2022

(54) WEAPON TRAINING ASSEMBLY

(71) Applicant: Bagira Systems Ltd., Holon (IL)

(72) Inventor: Yaron Mizrachi, Holon (IL)

(21) Appl. No.: 17/633,205

(22) PCT Filed: Sep. 22, 2021
(86) PCT No.: PCT/IB2021/058655

§ 371 Date: Feb. 6, 2022

(30) Foreign Application Priority Data
Sep. 23, 2020 (IL) 277534

(51) Int. Cl. F41A 33/02; F41A 9/62

(52) U.S. Cl. CPC F41A 33/02; F41A 9/62

(57) ABSTRACT

A weapons training assembly (WTA) for use with a weapon comprising: a magazine; a weapon adaptor, and a small arms transmitter (SAT), wherein one or both of the magazine and SAT comprise laser detectors, and wherein the weapon adaptor comprises one or more bolt detectors.

### CROSS REFERENCE TO RELATED APPLICATIONS

This is a 371 application from international patent application PCT/IB2021/058655 filed Sep. 22, 2021, which is related to and claims priority from IL Patent Application No. 277534 filed Sep. 23, 2020, which is expressly incorporated herein by reference in its entirety.

### TECHNICAL FIELD

Embodiments disclosed herein relate to simulator systems and, in particular, to a weapon training system.

### BACKGROUND

Intensive and frequent training of armed forces personnel is indispensable for the acquisition of the skills necessary to successfully complete military and law enforcement missions. However, the training of armed forces personnel to correctly and reliably handle weaponry is inherently dangerous in case live ammunition is being used for such training. Therefore, weapon simulator systems have been developed that do not require live ammunition during training of armed forces personnel in the handling of handheld or man-portable weapons.

Such a weapon simulator system may for example include a laser transmitter that is coupled to or mounted on a portable weapon such as, for example, a M16 rifle or a machine gun. The laser transmitter may emit laser light responsive to the pulling of the trigger of the weapon. The propagation of the emitted laser light is descriptive of the trajectory of live ammunition that would be fired by the weapon responsive to the pulling of the trigger.

Each soldier/trainee may be fitted with laser receivers for detecting a hit from another trainee to determine the location of a hit and optionally the time of the event and the identity of the shooter (if encoded by the emitted laser light). The laser receivers are generally incorporated into training vests and/or helmets that must be worn by trainees. These training vests add an additional clothing layer that is not part of the normal troop combat gear, thus disrupting the realism of the training. Further, training vests add an additional cost to the training system, require power and charging and must be managed and accounted for in training sessions.

Such a weapon simulator system may further include a trigger detector that needs to be mounted onto the trigger of the weapon for detecting a press of the trigger.

Most weapons include a fire-selector allowing changes to the fire-mode of the weapon, such as SAFE, SEMI, BURST, AUTO, and so forth. Such a weapon simulator system may further include a fire selector detector that needs to be mounted onto the fire selector of the weapon for detecting of a fire selector state.

### SUMMARY

This disclosure describes systems and methods for weapons training. A weapon training assembly (WTA) as disclosed herein includes a magazine, a small arms transmitter (SAT), and a weapon adaptor. The components of the WTA are mounted within and on a weapon enabling use of the real weapon for simulated weapons training. The SAT is mounted on the weapon barrel and the combined magazine and weapon adaptor are inserted into the magazine well of the weapon.

Advantageously, both of the SAT and magazine include optical detectors for detecting virtual hits from fellow trainees. Thus, the disclosed WTA provides for installation of optical detectors onto a weapon (as part of the same system used for virtual firing) and obviates the need for a separate detection vest and/or helmet. Further, the WTA includes a bolt detection mechanism for identifying charging of the bolt of the weapon in order to include weapon charging in the simulation. Still further, the WTA includes a trigger detector to detect trigger usage without the need for a specific trigger attachment on the trigger.

Still further, the WTA includes a fire selector detector to detect changes in the fire detector position without the need for a specific detector attachment on the fire selector. In some embodiments, the trigger detector and fire selector detector are combined.

In some embodiments, a WTA for use with a weapon comprises a magazine and a SAT, wherein the magazine comprises magazine optical detectors and the SAT comprises SAT optical detectors. In some embodiments, the WTA further comprises one or more bolt detectors.

In some embodiments, the WTA further comprises a weapon adaptor and the one or more bolt detectors are positioned on the weapon adaptor. In some embodiments, the WTA further comprises a trigger detector. In some embodiments, the weapon adaptor is adapted for installation in the weapon. In some embodiments, the magazine is sized and adapted for insertion into a magazine well of the weapon.

In some embodiments, the SAT comprises a barrel mount for mounting on a barrel of the weapon. In some embodiments, the SAT comprises a shot-flash light. In some embodiments, the magazine comprises a component selected from the group comprises a GPS receiver, a mobile data communication device, a short-range communication device, an audio amplifier, a battery, a speaker, and a virtual-ammunition count indicator.

In some embodiments, the weapon adaptor comprises a virtual round loaded indicator. In some embodiments, the magazine optical detectors and the SAT optical detectors are Multiple Integrated Laser Engagement System (MILES) compatible laser detectors.

In some embodiments, a method for weapons training comprises attaching the WTA to a weapon, inserting the magazine into the magazine well of the weapon to load virtual rounds, and charging the weapon with a bolt of the weapon to chamber one of the virtual rounds. In some embodiments, a method further comprises detecting a trigger press by the trigger detector and firing one of the virtual rounds. In some embodiments, the firing of one of the virtual rounds comprises one or more of: decreasing the number of available virtual rounds in the magazine, causing a laser transmission from a laser transmitter on the SAT, causing a sound from the speaker, or causing a light flash from shot-flash light.

In some embodiments, a method further comprises when the virtual rounds are exhausted, requiring removal and reinsertion of the magazine for reloading virtual rounds. In some embodiments, a method further comprises, charging of the bolt for chambering one of the virtual rounds for firing. In some embodiments, a method further comprises detecting a hit by one of the magazine optical detectors or SAT optical detectors. In some embodiments, when a hit is detected, performing one or more of: emitting a sound, preventing further virtual shooting from the weapon, or flashing a light source.

In some embodiments, a WTA for use with a real weapon comprises a plurality of optical detectors, wherein the plurality of optical detectors are adapted for attachment to the real weapon. In some embodiments, the WTA further comprises a magazine and a SAT, wherein the plurality of optical detectors are provided on one or both of the magazine and/or the SAT and wherein the magazine and the SAT are adapted for attachment to the real weapon.

In some embodiments, a WTA for use with a real weapon comprises a bolt detector for attachment to the real weapon. In some embodiments, the bolt detector is provided on the magazine, and the magazine and the SAT are adapted for attachment to the real weapon. In some embodiments, the WTA further comprises a weapon adaptor attached to the magazine, wherein the bolt detector is provided on the weapon adaptor.

As used herein the terms virtual ammunition, virtual firing, virtual hit and similar terms relate to use of the disclosed system in methods for simulated use of weapons such as for training purposes.

### BRIEF DESCRIPTION OF THE DRAWINGS

Aspects, embodiments and features disclosed herein will become apparent from the following detailed description and claims when considered in conjunction with the accompanying drawings. In the drawings:

FIG. 1 shows a weapons training assembly according to some embodiments.

FIGS. 2A-2B show a small arms transmitter of a weapons training assembly according to some embodiments.

FIGS. 3A-3F show a weapon adaptor and magazine of a weapons training assembly according to some embodiments.

FIG. 4 is a flowchart showing a process for operation of a weapons training assembly as part of a weapon training session according to some embodiments.

### DETAILED DESCRIPTION

Reference will now be made in detail to non-limiting examples of this disclosure, examples of which are illustrated in the accompanying drawings. The examples are described below by referring to the drawings, wherein like reference numerals refer to like elements. When like reference numerals are shown, corresponding description(s) are not repeated, and the interested reader is referred to the previously discussed figure(s) for a description of the like element(s).

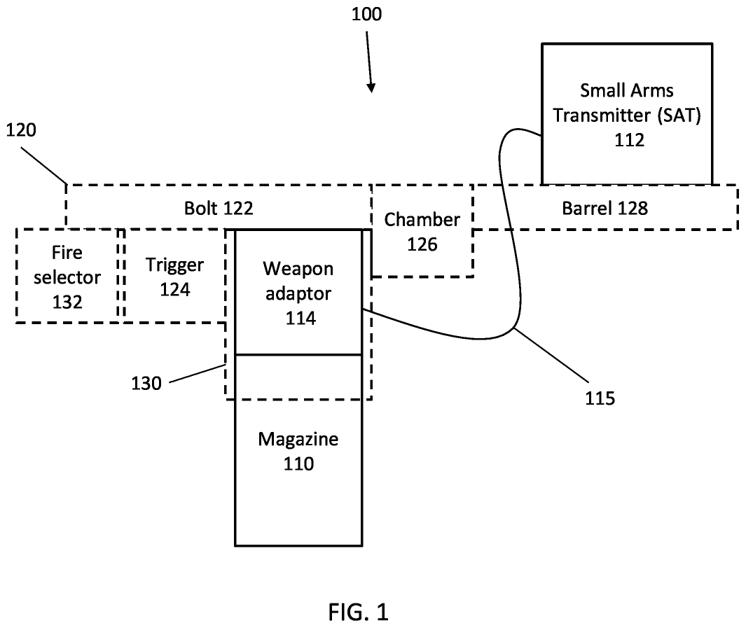

Embodiments disclosed herein relate to a weapons training assembly (WTA). FIG. 1 shows a weapons training assembly according to some embodiments. The components of WTA 100 are mounted on and within a weapon 120. WTA 100 includes a magazine 110, small arms transmitter (SAT) 112 and weapon adaptor 114. In some embodiments, cable 115 connects weapon adaptor 114 (and magazine 110) with SAT 112. In some embodiments, weapon adaptor 114 and magazine 110 are connected wirelessly with SAT 112 and cable 115 is not required.

Magazine 110 includes a microcontroller (MCU) 116, which is a computing device for managing functionality for WTA 100, including but not limited to: processing, storage, wired and wireless communication, laser actuation and detection, bolt and trigger detection, and sound and light actuation. SAT 112 also includes an MCU 118, which is a computing device in communication with MCU 116 for managing SAT functionality including but not limited to: generating laser codes, generating flashes, decoding incoming lasers and transmitting the incoming laser decoded info to MCU 116.

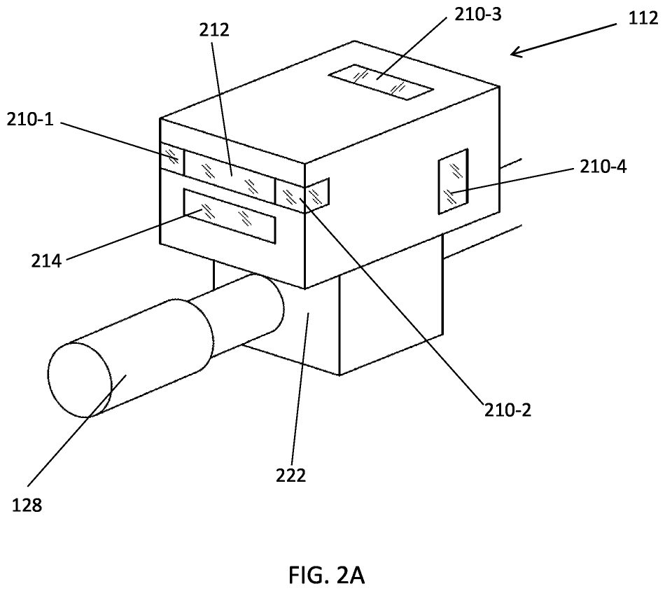

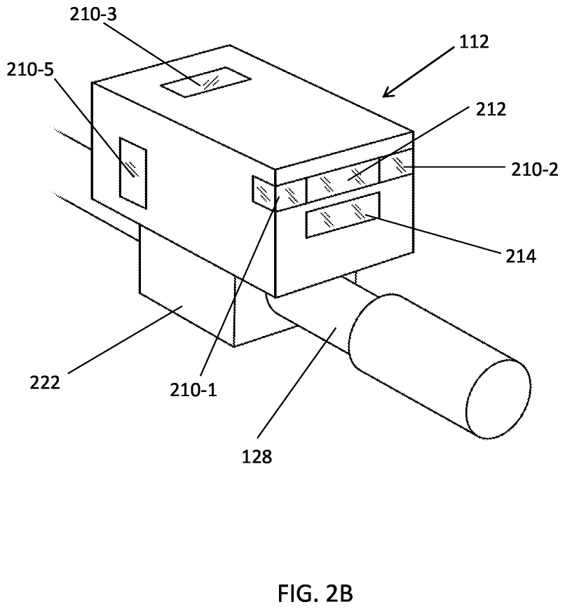

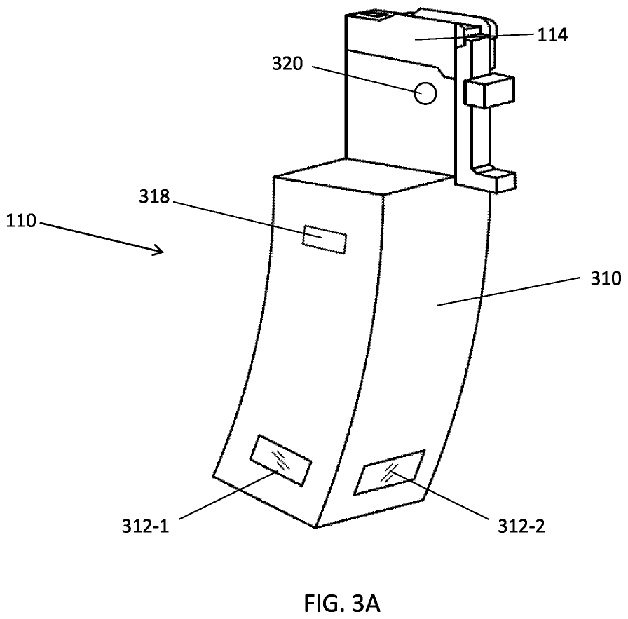

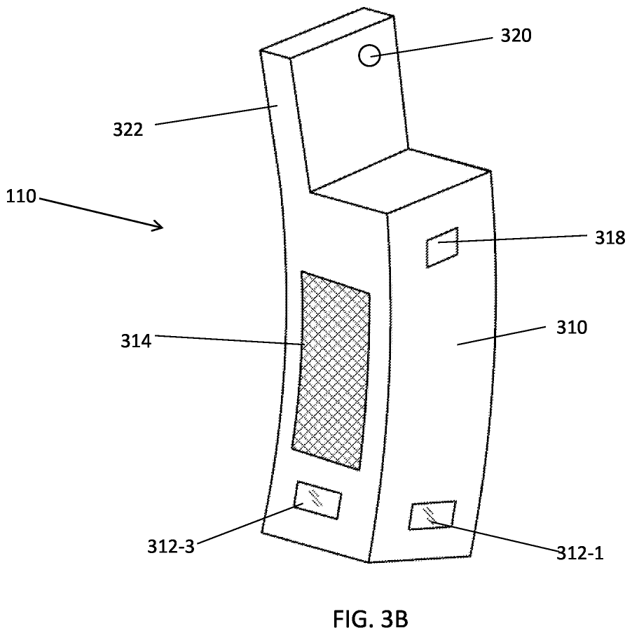

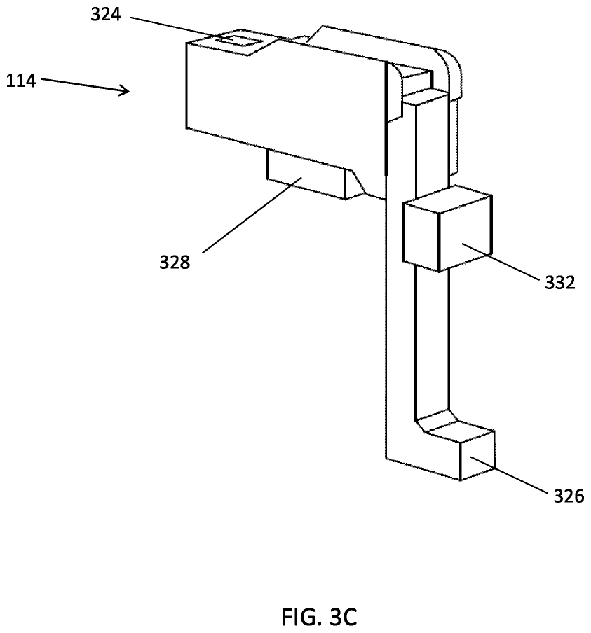

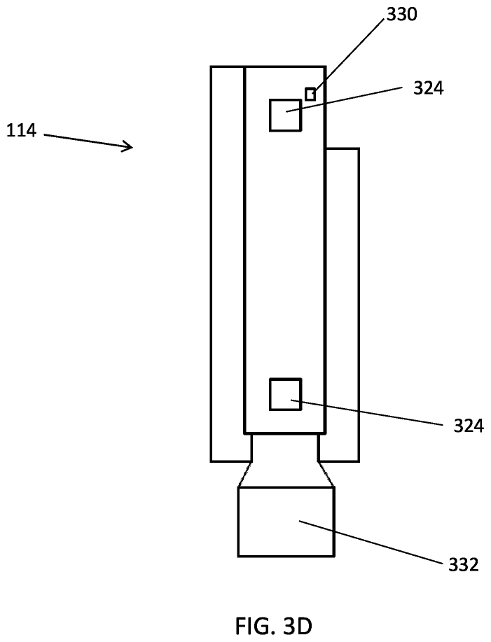

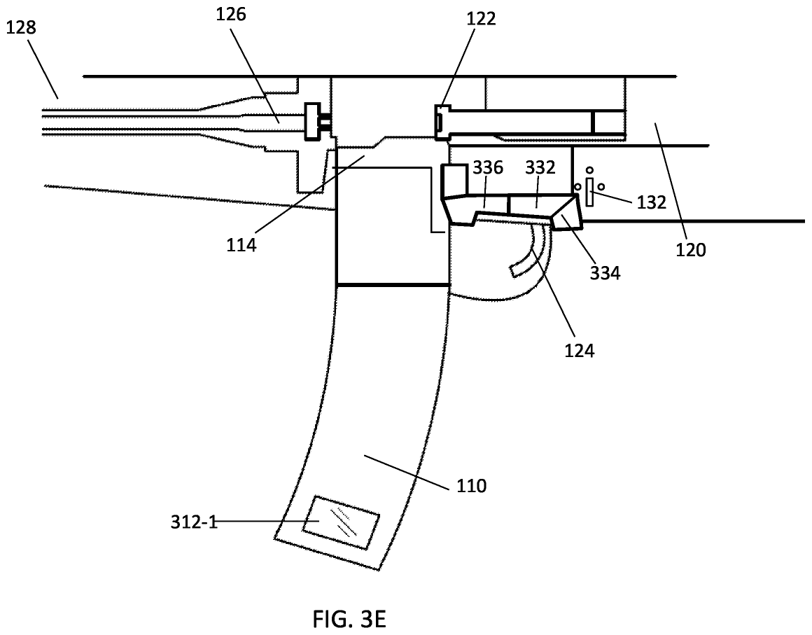

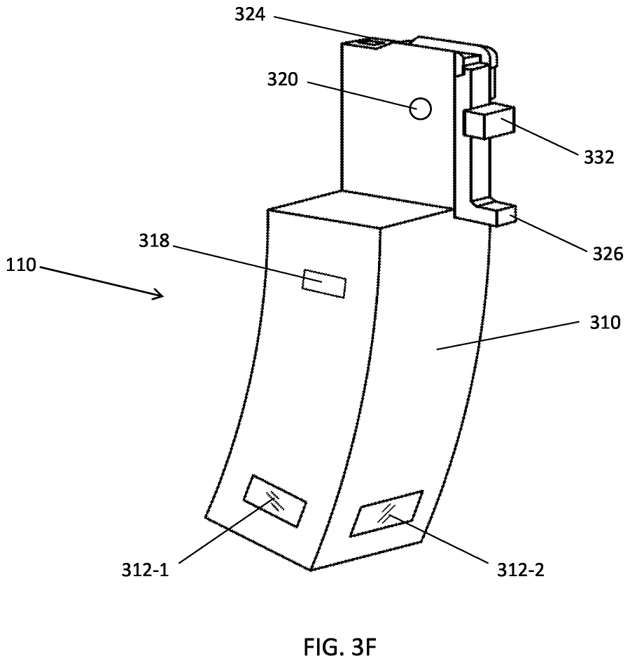

A simplified form of weapon 120 is shown in FIG. 1 for illustrative purposes. Weapon 120 includes a bolt 122, a trigger 124, a fire selector 132, a chamber 126, a barrel 128, and a magazine well 130. In some embodiments, weapon 120 is a real weapon capable of firing live ammunition (such as an M4, M16, M60, K1, K2, and K3) that is adapted for training by using the WTA 100 disclosed herein. Alternatively, weapon 120 is a replica of a real weapon that cannot fire live ammunition or is a training weapon that is not a replica of another weapon. It should be appreciated that weapon 120 further includes other typical weapon components that are not shown for simplicity. The components of WTA 100 are further described below with reference to FIGS. 2A-2B and 3A-3E.

FIGS. 2A-2B shows details of a small arms transmitter of a weapons training assembly according to some embodiments. As shown in FIGS. 2A-2B, SAT 112 is shown attached to barrel 128 of weapon 120 using a barrel mount 222. SAT 112 includes one or more laser detectors 210. In some embodiments, five laser detectors 210 are provided on the front, top and sides of SAT 112. These are shown in FIGS. 2A and 2B as laser detectors 210-1, 210-2, 210-3, 210-4 and 210-5. In some embodiments, laser detectors 210 are Multiple Integrated Laser Engagement System (MILES) compatible laser detectors.

SAT 112 further includes a laser transmitter 214. In some embodiments, laser transmitter 214 is a MILES compatible laser transmitter. In some embodiments, multiple laser transmitters 214 are provided.

SAT 112 further includes a shot-flash light 212 that is activated when a shot is fired by WTA 100. In some embodiments, shot-flash light 212 may include for example an LED, a laser, or an infrared (IR) light.

FIGS. 3A-3F show a weapon adaptor 114 and magazine 110 of a weapons training assembly 100 according to some embodiments. FIGS. 3A and 3B show alternate views and details of magazine 110. FIGS. 3C-3D show alternate side and top views and details of weapon adaptor 114. FIG. 3E shows weapon 120 having magazine 110 and weapon adaptor 114 inserted therein. FIG. 3F shows an alternative embodiment of magazine 110.

Magazine 110 includes a magazine body 310 generally shaped to resemble a real magazine and sized and adapted for insertion into magazine well 130. For example, in some embodiments, a magazine catch 320 is provided on magazine top 322 to mechanically couple to a matching feature (not shown) on an internal wall of magazine well 130. It should be appreciated that magazine 110 and weapon adaptor 114 are adapted in size, shape and position of sensors for the particular weapon 120 that they will be used within. Although FIGS. 3A-3E show weapon adaptor 114 and magazine 110 as separate components, in some embodiments, such as shown in FIG. 3F, magazine 110 is a single unit including all of the components of weapons adaptor 114 and in the embodiment of FIG. 3F no weapon adaptor 114 is required.

Magazine 110 includes one or more laser detectors 312. In some embodiments, four laser detectors 312 are provided, on each of four sides of magazine 110. Laser detectors 312-1, 312-2, and 312-3 are shown in FIGS. 3A and 3B. In some embodiments, a laser detector 312 is provided on the underside (not shown) of magazine 110. In some embodiments, laser detectors 312 are MILES compatible laser detectors.

In some embodiments, magazine 110 includes some or all of the following internal components (not shown): a GPS receiver, a mobile data communication device, a short-range communication device, and an audio amplifier. Magazine 110 includes a battery that provides power to magazine 110, SAT 112 and weapon adaptor 114. In some embodiments, SAT 112 includes a battery and does not receive power from magazine 110. Magazine 110 also includes a speaker 314 and a virtual-ammunition count indicator 318. Magazine body 310 may be made of a material similar to or identical with that of a real magazine, e.g. a metal or reinforced plastic. In some embodiments, speaker 314 is capable of outputting up to 135 dB firing sounds.

Weapon adaptor 114 is installed inside weapon 120 at the top of magazine well 130. Once installed, it is not possible for cartridges of a regular cartridge-carrying magazine to bypass weapon adaptor 114 for chambering as weapon adaptor 114 blocks the top of magazine well 130. When magazine 110 is inserted into magazine well 130, weapon adaptor 114 attaches to the magazine top part 322 of magazine 110 via a weapon adaptor connector 328. In some embodiments, a mechanical sliding spring connector (not shown) on weapon adaptor 114 holds magazine top part 322.

FIGS. 3A and 3E show weapon adaptor 114 attached to magazine 110. The attachment of weapon adaptor 114 to magazine 110 enables data communication between weapon adaptor 114 and magazine 110 via weapon adaptor connector 328. Weapon adaptor 114 includes one or more bolt detectors 324 for detecting the movement and positioning of bolt 122. Thus, weapon adaptor 114 can detect that a trainee has charged bolt 122 and may “refill” a virtual bullet count. In some embodiments, bolt detectors 324 may include magnets for detecting bolt 122.

In some embodiments, weapon adaptor 114 further includes a virtual round loaded indicator 330. In some embodiments, following virtual charging of weapon 120 (pulling back and releasing bolt 122 with weapon adaptor inside weapon 120), virtual round loaded indicator 330 is lit to indicate that a virtual round is loaded for firing. Weapon adaptor further includes a trigger detector 332. The position and type of trigger detector 332 will depend on the weapon type and operation of the trigger 124. Trigger detector 332 includes one or more of a trigger contact sensor, hall sensor, inductive sensor or optical sensor. In some embodiments, trigger detector 332 detects trigger 124 movement by analog measurement of the trigger stroke.

Weapon adaptor 114 further includes a fire selector detector 334. In some embodiments, one or more magnets 336 are provided for attachment of the detectors 332 and 334 to the weapon 120. Detectors 332 and 334 are in data communication with weapon adaptor 114 via wired or wireless communications. It should be appreciated that the shape of a trigger detector 332 and fire selector detector 334 as well as the position of magnets 336 will be dependent on the physical structure of the weapon 120 to be used. The position and type of fire selector detector 334 will depend on the weapon type and operation of the fire selector 132.

In some embodiments, as shown in FIG. 3E, detectors 332 and 334 are respectively positioned proximal to trigger 124 and fire selector 132. In some embodiments, fire selector detector 334 senses the position of fire selector 132 by a change in electromagnetic (EM) field caused by movement of fire selector 132, as detected by EM field sensor/s within the proximal fire selector detector 334. In some embodiments, trigger detector 332 may detect a trigger pull by trigger 124 based on a change in the EM field change sensed by the EM field sensor/s within proximal fire selector detector 334. In some embodiments, fire selector detector 334 may include one or more of a contact sensor, hall sensor, inductive sensor, or optical sensor for sensing the position of fire selector 132.

Weapon adaptor 114 includes a wired communication and power connector 326 for connecting weapon adaptor 114 (and magazine 110) with SAT 112 using cable 115 (FIG. 1). In some embodiments, communication between SAT 112 and weapon adaptor 114 and/or magazine 110 is wireless. In some embodiments, SAT 112 includes its own power supply and no wired connection is required between SAT 112 and magazine 110.

In use, magazine 110 is inserted and removed from a weapon just like a real magazine. Count indicator 318 indicates the number of virtual shots fired and magazine 110 stops the virtual firing after a predetermined number of virtual shots (e.g. 29 virtual shots in a regular training magazine), when the magazine is “empty”. The magazine must then be removed and reinserted and a bolt 122 charge must be detected by weapon adaptor 114 to reset the virtual ammunition count.

When trigger 124 is pressed, the action is detected by trigger detector 332 and conveyed to magazine 110. The virtual ammunition count is checked to see if there are virtual cartridges in the magazine. If Yes, a shot accompanied by sound and light effects is fired. If No (the counter indicates zero virtual cartridges), there is no shot. The trainee then needs to change the magazine, i.e. remove it from, and reinsert it into the weapon and charge the bolt.

Upon detection and registration of a hit by one of detectors 210 and/or 312, magazine MCU 116 may perform post-hit actions. Post hit actions include but are not limited to emitting a sound such as through speaker 314, preventing further shooting from weapon 120, and/or flashing a light source worn by the trainee.

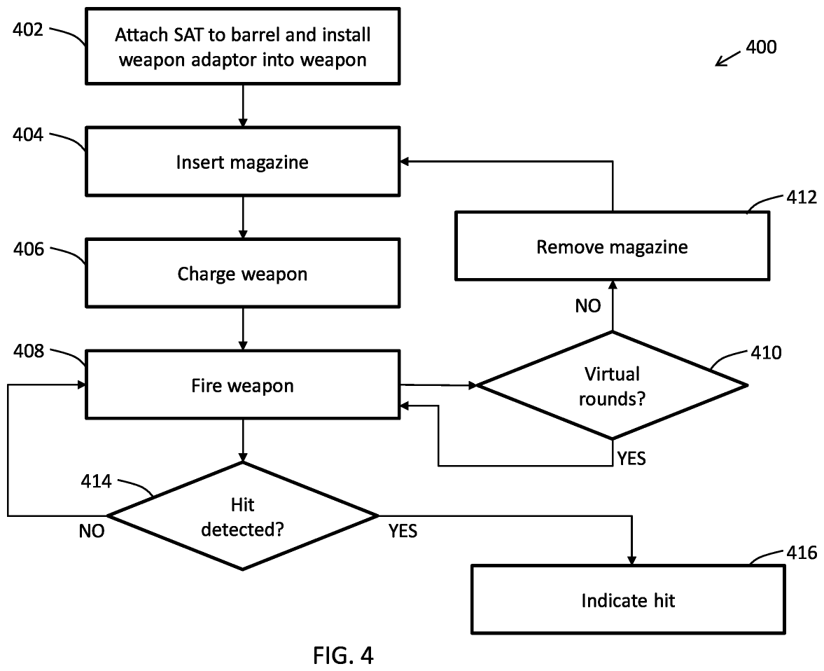

FIG. 4 is a flowchart showing a process 400 for operation of a weapons training assembly as part of a weapon training session. Process 400 makes use of the WTA 100 mounted on and within a weapon 120 as described above. Prior to starting use of WTA 100, the weapon is unloaded including removal of any magazines and checking for and removal of any loaded cartridges.

In step 402 of process 400, weapon adaptor 114 is installed into the top of magazine well 130. SAT 112 is clamped onto barrel 128 using barrel mount 222. SAT 112 is connected to weapon adaptor 114 using connector 326. In step 404, magazine 110 is inserted into magazine well 130 to engage with weapon 120, such as with magazine catch 320. Magazine 110 engages and connects to weapon adaptor connector 328. Magazine 110, SAT 112 and weapon adaptor 114 are now activated and in data communication.

Further, magazine 110 is updated to have a full magazine's worth of virtual rounds for use in the weapon training. The number or level of fullness of magazine 110 with virtual rounds is shown by ammunition count indicator 318.

In step 406, weapon 120 is charged by charging bolt 122. Weapon adaptor 114 detects the weapon charge and “chambers” a virtual round as indicated by virtual round indicator 330.

In some embodiments, fire selector 132 is switched form a “safety” position to a firing position and fire selector detector 334 detects that the weapon may now be fired.

Weapon 120 is now ready to be virtually fired as part of training.

In step 408, a trainee presses trigger 124 to fire a virtual round. The trigger press is detected by trigger detector 332 of weapon adaptor 114 and communicated to magazine MCU 116. In response to firing a virtual round, MCU 116 performs one or more of: decreasing the number of available rounds in magazine 110; causing a laser transmission from laser transmitter 214; causing a sound from speaker 314; and/or causing a light flash from shot flash light 212. Virtual rounds are targeted according to the aiming direction of laser transmitter 214. WTA 100 may be used for firing at other trainees having detectors 210 and/or 312 attached to their weapons, and/or trainees with detectors on their clothing (helmets, vests), and/or static or mobile targets.

After step 408, before another virtual round can be fired, MCU 116 determines whether any virtual rounds remain. As long as virtual rounds remain, they may be fired as step 408 is repeated. When no virtual rounds remain, the trainee needs to perform those actions that simulate reloading and charging the weapon. Thus, in step 412, magazine 110 must be removed and then steps 404 (insert magazine) and 406 (charge weapon) are performed again. After step 406, weapon 120 is again ready for virtual firing.

In step 414, it is detected by any of laser detectors 210 and/or 312 that a laser virtual shot of another weapon has “hit” weapon 120 (herein referred to as a “virtual hit”). Detection of a hit is here shown as occurring after step 408, but in practice a hit may be detected by detectors 312 even before insertion of magazine 110 in step 404. Detection of a hit by detectors 210 can only occur after step 404 once magazine 110 is supplying power to SAT 112. In some embodiments, a head detector on a helmet (not shown) is also able to detect hits. The hit detection is communicated to MCU 116. In step 416, the hit is indicated by one or more of: emitting a sound such as through speaker 314, preventing further shooting from weapon 120, and/or flashing a light source worn by the trainee such as on a helmet.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure could be described as being performed by a data processor, such as a computing device for executing a plurality of instructions.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment or implementation are necessary in every embodiment or implementation of the invention. Further combinations of the above features and implementations are also considered to be within the scope of some embodiments or implementations of the invention.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made.

1. A weapons training assembly (WTA) for use with a weapon, comprising:
a magazine; and
a small arms transmitter (SAT),
wherein the magazine comprises magazine optical detectors for detecting that a laser virtual shot of another weapon has hit the weapon, and wherein the SAT comprises SAT optical detectors.

2. The WTA of claim 1, further comprising one or more bolt detectors.

3. The WTA of claim 2, further comprising a weapon adaptor and wherein the one or more bolt detectors are positioned on the weapon adaptor.

4. The WTA of claim 1, further comprising a trigger detector and/or a fire selector detector.

5. The WTA of claim 3, wherein the weapon adaptor is adapted for installation in the weapon.

6. The WTA of claim 1, wherein the magazine is sized and adapted for insertion into a magazine well of the weapon.

7. The WTA of claim 1, wherein the SAT comprises a barrel mount for mounting on a barrel of the weapon.

8. The WTA of claim 1, wherein the SAT comprises a shot-flash light.

9. The WTA of claim 1, wherein the magazine comprises a component selected from the group consisting of a GPS receiver, a mobile data communication device, a short range communication device, an audio amplifier, a battery, a speaker, and a virtual-ammunition count indicator.

10. The WTA of claim 3, wherein the weapon adaptor comprises a virtual round loaded indicator.

11. The WTA of claim 1, wherein the magazine optical detectors and the SAT optical detectors are Multiple Integrated Laser Engagement System (MILES) compatible laser detectors.

12. A method for weapons training, comprising:
attaching the WTA of claim 4 to a weapon;
inserting the magazine into the magazine well of the weapon to load virtual rounds; and
charging the weapon with a bolt of the weapon to chamber one of the virtual rounds.

13. The method of claim 12, further comprising detecting a trigger press by the trigger detector and firing one of the virtual rounds.

14. The method of claim 13, wherein the firing of one of the virtual rounds comprises one or more of: decreasing the number of available virtual rounds in the magazine, causing a laser transmission from a laser transmitter on the SAT, causing a sound from the speaker, or causing a light flash from shot-flash light.

15. The method of claim 14, further comprising when the virtual rounds are exhausted, requiring removal and reinsertion of the magazine for reloading virtual rounds.

16. The method of claim 15, further comprising charging of the bolt for chambering one of the virtual rounds for firing.

17-24. (canceled)
